(19) United States
(12) Patent Application Publication
(10) Pub. No.: US 2017/0010724 A1
(43) Pub. Date: Jan. 12, 2017

(54) LIQUID CRYSTAL DISPLAY DEVICE WITH TOUCH-SENSING FUNCTION AND CONDUCTIVE LAYER STRUCTURE THEREOF

(71) Applicant: Wuhan China Star Optoelectronics Technology Co., Ltd., Wuhan, Hubei (CN)

(72) Inventors: Chang CAO, Shenzhen, Guangdong (CN); Yuzheng CAI, Shenzhen, Guangdong (CN); Gonghua ZOU, Shenzhen, Guangdong (CN)

(73) Assignee: Wuhan China Star Optoelectronics Technology Co., Ltd., Wuhan, Hubei (CN)

(21) Appl. No.: 14/770,932

(22) PCT Filed: Jul. 17, 2015
(86) PCT No.: PCT/CN2015/084311

§ 371 Date: Aug. 27, 2015

(30) Foreign Application Priority Data
Jul. 6, 2015 (CN) 2015103903809

(51) Int. Cl. G06F 3/041; G02F 1/1333; G02F 1/1343; G06F 3/044

(52) U.S. Cl. CPC G06F 3/0412; G06F 3/044; G02F 1/13338; G02F 1/134336; G02F 1/13439; G06F 2203/04112; G02F 2201/121

(57) ABSTRACT

The invention provides a liquid crystal display device with touch-sensing function and a conductive layer structure thereof. Multiple first electrode patterns of the conductive layer structure are arranged around multiple second electrode patterns; each of the multiple first electrode patterns includes a first sub-electrode pattern and a second sub-electrode pattern, a first side of the first sub-electrode pattern near the second sub-electrode pattern and a second side of the second sub-electrode pattern near the first sub-electrode pattern each are disposed with a right angle structure, and the first side and the second side are meshed with each other to thereby make the first electrode pattern and the second sub-electrode pattern together define a rectangular shape. The invention can improve the touch precision of the edge region of a self-capacitor touch panel.

### TECHNICAL FIELD

The invention relates to the technical field of touch-sensing screen, and particularly to a conductive layer structure and a liquid crystal display device with touch-sensing function having the conductive layer structure.

### DESCRIPTION OF RELATED ART

Nowadays, a liquid crystal display device integrating with touch-sensing function and display function is becoming more popular, and In-cell technology embedding capacitive touch-sensing function into pixels of a liquid crystal display panel, which is easy to realize characteristics of thin and lightweight of the liquid crystal display panel, especially has become the development trend of the art. A conductive layer structure of the liquid crystal display panel using the in-cell technology only is composed of multiple same touch electrode patterns each having a rectangular shape, that is a traditional full in-cell conductive layer structure, when fingers slide around the edge region of a touch screen of the liquid crystal display device, a capacitance between electrode patterns of the edge region changes larger, the difference between a capacitance change and a linear change is bigger when the fingers slide from one touch point to another touch point, therefore it is unable to effectively judge a sliding track of the fingers, a touch precision of the edge region is poorer.

### SUMMARY

Accordingly, embodiments of the invention provide a liquid crystal display device with touch-sensing function and a conductive layer structure thereof to improve the touch precision of the edge region of the liquid crystal display device.

An embodiment of the invention provides a conductive layer structure, comprises a plurality of first electrode patterns and a plurality of rectangular second electrode patterns, the plurality of second electrode patterns are arranged in a rectangular array, the plurality of first electrode patterns are arranged around the plurality of second electrode patterns; the plurality of second electrode patterns arranged in a rectangular array are disposed with two rows of the first electrode patterns on a row direction thereof respectively located above and below the plurality of second electrode patterns, and further are disposed with two columns of the first electrode patterns on a column direction thereof respectively located left and right of the plurality of second electrode patterns, a length and a width of each of the plurality of first electrode patterns respectively are equal to a length and a width of each of the plurality of second electrode patterns; wherein, each of the plurality of first electrode patterns comprises a first sub-electrode pattern and a second sub-electrode pattern, a first side of the first sub-electrode pattern near the second sub-electrode pattern and a second side of the second sub-electrode pattern near the first sub-electrode pattern each are disposed with a right angle structure, and the first side and the second side are meshed with each other to thereby make the first sub-electrode pattern and the second sub-electrode pattern together define a rectangular shape, and a distance between one of the plurality of first electrode patterns and one of the plurality of second electrode patterns adjacent thereto is equal to a distance between the first sub-electrode pattern and the second sub-electrode pattern.

Another embodiment of the invention provides a conductive layer structure, comprises a plurality of first electrode patterns and a plurality of rectangular second electrode patterns, the plurality of second electrode patterns are arranged in a rectangular array, the plurality of first electrode patterns are arranged around the plurality of second electrode patterns; wherein each of the plurality of first electrode patterns comprises a first sub-electrode pattern and a second sub-electrode pattern, a first side of the first sub-electrode pattern near the second sub-electrode pattern and a second side of the second sub-electrode pattern near the first sub-electrode pattern each are disposed with a right angle structure, the first side and the second side are meshed with each other to thereby make the first electrode pattern and the second sub-electrode pattern together define a rectangular shape.

In one embodiment, a length and a width of each of the plurality of first electrode patterns respectively are equal to each of the plurality of second electrode patterns.

In one embodiment, the first sub-electrode pattern and the second sub-electrode pattern each are a “L” shaped structure.

In one embodiment, the first sub-electrode pattern is an “E” shaped structure, the first side of the first sub-electrode pattern comprises two recesses with the right angle structure, and the second side of the second sub-electrode pattern comprises two convexes meshed with the two the recesses.

In one embodiment, a distance between one of the plurality of first electrode patterns and an adjacent one of the plurality of second electrode patterns is equal to a distance between the first sub-electrode pattern and the second sub-electrode pattern.

In one embodiment, the plurality of second electrode patterns arranged in a rectangular array are disposed with two rows of the first electrode patterns on a row direction thereof respectively located above and below the plurality of second electrode patterns, and further are disposed with two columns of the first electrode patterns on a column thereof respectively located left and right of the plurality of second electrode patterns.

In one embodiment, each of the plurality of first electrode patterns located on the row direction rotates with 90 degrees to the right or to the left would become the same as corresponding one of the plurality of first electrode patterns located on the column direction.

In one embodiment, the two columns of the first electrode patterns located on the column direction are symmetrical with respect to a first axis, and two rows of the first electrode patterns located on the row direction are symmetrical with respect to a second axis, the first axis and the second axis respectively are central axes of the multiple second electrode patterns arranged in a rectangular array on the column direction and on the row direction

In one embodiment, the two columns of the first electrode patterns located on the column direction are the same, and the two rows of the first electrode patterns located on the row direction are the same.

Further another embodiment of the invention provides a liquid crystal display device with touch-sensing function, comprises a display assembly and a touch-sensing assembly, the display assembly and the touch-sensing assembly share a common electrode, the touch-sensing assembly comprises a conductive layer structure disposed opposite to the common electrode, the conductive layer structure comprises a plurality of first electrode patterns and a plurality of rectangular second electrode patterns, the plurality of second electrode patterns are arranged in a rectangular array, the plurality of first electrode patterns are arranged around the plurality of second electrode patterns, each of the plurality of first electrode patterns comprises a first sub-electrode pattern and a second sub-electrode pattern, a first side of the first sub-electrode pattern near the second sub-electrode pattern and a second side of the second sub-electrode pattern near the first sub-electrode pattern each are disposed with a right angle structure, the first side and the second side are meshed with each other to thereby make the first electrode pattern and the second sub-electrode pattern together define a rectangular shape.

In one embodiment, a length and a width of each of the plurality of first electrode patterns are respectively equal to a length and a width of each of the plurality of second electrode patterns.

In one embodiment, the first sub-electrode pattern and the second sub-electrode pattern each are a “L” shaped structure.

In one embodiment, the first sub-electrode pattern is an “E” shaped structure, the first side of the first sub-electrode pattern comprises two recesses with the right angle structure, and the second side of the second sub-electrode pattern comprises two convexes meshed with the two the recesses.

In one embodiment, a distance between one of the plurality of first electrode patterns and an adjacent one of the plurality of second electrode patterns is equal to a distance between the first sub-electrode pattern and the second sub-electrode pattern.

In one embodiment, the plurality of second electrode patterns arranged in a rectangular array are disposed with two rows of the first electrode patterns on a row direction thereof respectively located above and below the plurality of second electrode patterns, and further are disposed with two columns of the first electrode patterns on a column thereof respectively located left and right of the plurality of second electrode patterns.

In one embodiment, each of the plurality of first electrode patterns located on the row direction rotates with 90 degrees to the right or to the left would become the same as the first electrode pattern located on the column direction.

In one embodiment, the two columns of the first electrode patterns located on the column direction are symmetrical with respect to a first axis, and two rows of the first electrode patterns located on the row direction are symmetrical with respect to a second axis, the first axis and the second axis respectively are central axes of the plurality of second electrode patterns arranged in a rectangular array on the column direction and on the row direction.

In one embodiment, the two columns of the first electrode patterns located on the column direction are the same, and the two lines of the first electrode patterns located on the row direction are the same.

With regard to a liquid crystal display device with touch-sensing function and a conductive layer structure thereof according to embodiments of the invention, an electrode pattern being designed to be located around an edge region of the conductive layer structure includes two sub-electrode patterns, and adjacent sides of the two sub-electrode patterns each are disposed with a right angle structure, which is equivalent to increase the contact area between the electrode patterns in a sensing unit, when fingers slide around the edge region of a touch screen of the liquid crystal display device, a capacitance change between electrode patterns of the edge region is relatively small, a capacitance change during sliding from one touch point to another touch point is consistent with a linear change, thus it is able to accurately judge a sliding track of the fingers.

### BRIEF DESCRIPTION OF THE DRAWINGS

FIG. 1 is a structural schematic view of an embodiment of a conductive layer structure of the invention;

FIG. 2 is a first operating principle schematic view of a conductive layer structure according to an embodiment of the invention;

FIG. 3 is a second operating principle schematic view of a conductive layer structure according to an embodiment of the invention; and

FIG. 4 a structural schematic view of another embodiment of a first electrode pattern of the invention.

### DETAILED DESCRIPTION OF EMBODIMENTS

In the following, with reference to accompanying drawings, technical solutions of exemplary embodiments provided by the invention will be clearly and completely described.

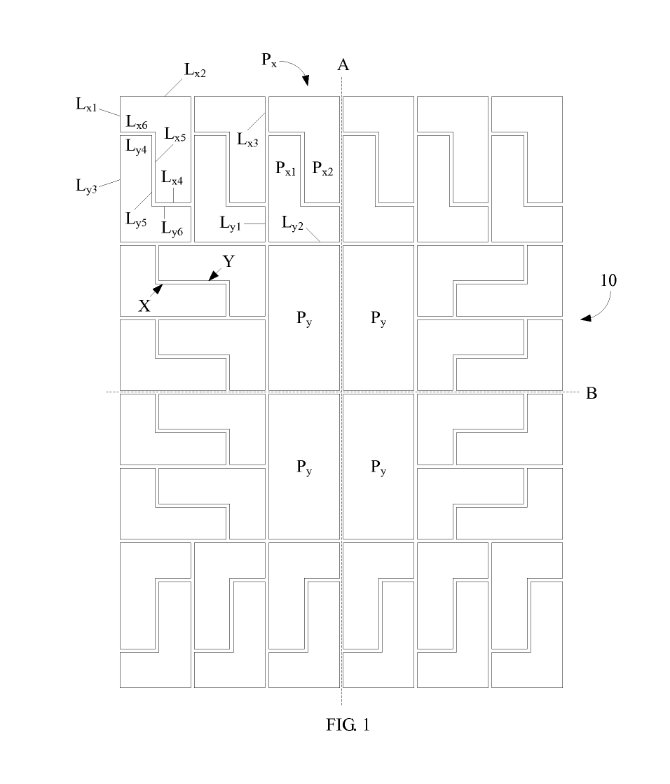

Referring to FIG. 1, a conductive layer structure 10 of an embodiment of the invention is disposed on the surface of a substrate made of glass or film materials, includes multiple first electrode patterns Pₓ and multiple rectangular second electrode patterns P_{y} (not limited to the four shown in the figure), the multiple second electrode patterns P_{y} are arranged in a rectangular array, the multiple first electrode patterns Pₓ are arranged around the multiple second electrode patterns P_{y} arranged in a rectangular array, each first electrode pattern Pₓ includes one first sub-electrode pattern Pₓ₁ and one second sub-electrode pattern Pₓ₂, a first side X of the first sub-electrode pattern near the second sub-electrode pattern is disposed with a right angle structure, a second side Y of the second sub-electrode pattern near the first sub-electrode pattern is further disposed with a right angle structure, and the first side X and the second side Y are meshed with each other to thereby make the first electrode pattern Pₓ formed by the first sub-electrode pattern Pₓ₁ and the second sub-electrode pattern Pₓ₂ define a rectangular shape.

The first sub-electrode pattern Pₓ₁ and the second sub-electrode pattern Pₓ₂ each are a “L” shaped structure, that is, each first sub-electrode pattern Pₓ₁ has six sides Lₓ₁, Lₓ₂, Lₓ₃, Lₓ₄, Lₓ₅, Lₓ₆, each second sub-electrode pattern Pₓ₂ further has six sides L_{y1}, L_{y2}, L_{y3}, L_{y4}, L_{y5}, L_{y6}, and the side L_{y4}, L_{y5}, L_{y6} form the first side X, the side Lₓ₄, Lₓ₅ and the side Lₓ₅, Lₓ₆ respectively form two right angle structures of the first side X, the side L_{y4}, L_{y5}, L_{y6} form the second side Y, the side L_{y4}, L_{y5} and the side L_{y5}, L_{y6} respectively form two right angle structures of the second side Y, the side L_{y4} is adjacent to the side L_{y6}, the side Lₓ₅ is adjacent to the side L_{y5}, the side Lₓ₆ is adjacent to the side L_{y4}.

Accordingly, on a row direction, a length of each first electrode pattern Pₓ is equal to a length of the side Lₓ₂, on a column direction, a width of each first electrode pattern Pₓ is equal to a sum of a length of the side Lₓ₁, a length of the side L_{y3} and a distance between the two. The embodiment can further dispose the length of each first electrode pattern Pₓ be equal to a length of each second electrode pattern P_{y} and dispose the width of each first electrode pattern Pₓ be equal to a width of each second electrode pattern P_{y}. Optionally, a distance between each first electrode pattern Pₓ and a second electrode pattern P_{y} adjacent thereto is equal to a distance between the first sub-electrode pattern Pₓ₁ and the second sub-electrode pattern Pₓ₂.

In the embodiment, the multiple second electrode patterns P_{y} arranged in a rectangular array are disposed with two rows of the first electrode patterns Pₓ on a row direction thereof respectively located above and below the multiple second electrode patterns P_{y}, the multiple second electrode patterns P_{y} arranged in a rectangular array are disposed with two columns of first electrode patterns Pₓ on a column direction thereof respectively located left and right of the multiple second electrode patterns P_{y}.

After rotating with 90 degrees to the right, the first electrode pattern Pₓ located above the multiple second electrode patterns P_{y} would become the same as the first electrode pattern Pₓ located right of the multiple second electrode patterns P_{y}, after rotating with 90 degrees to the left, the first electrode pattern Pₓ located below the multiple second electrode patterns P_{y} would become the same as the first electrode pattern Pₓ located left of the multiple second electrode patterns P_{y}, and two columns of the first electrode patterns Pₓ located on the column direction are symmetrical with respect to a first axis A, and two rows of the first electrode patterns Pₓ located on the row direction are symmetrical with respect to a second axis B, the first axis A and the second axis B respectively are central axes of the multiple second electrode patterns P_{y} arranged in a rectangular array on the column direction and on the row direction.

Assuredly, in other embodiments of the invention, two columns of first electrode patterns Pₓ located on the column direction may be the same, and two rows of first electrode patterns Pₓ located on the row direction are the same.

The multiple first electrode patterns Pₓ and the multiple second electrode patterns P_{y} of the embodiment respectively are made of ITO (Indium Tin Oxide) or other transparent conducting materials, and one of the multiple first electrode patterns Pₓ formed by one first sub-electrode pattern Pₓ₁ and one second sub-electrode pattern Pₓ₂ is used as a sensing unit of the conductive layer structure 10 (i.e., touch screen), each of the multiple second electrode pattern P_{y} is used as a sensing unit of the conductive layer structure 10 (i.e., touch screen). Moreover, the multiple first electrode patterns Pₓ located on an edge region of the conductive layer structure 10 are equivalent to an edge region of the touch screen.

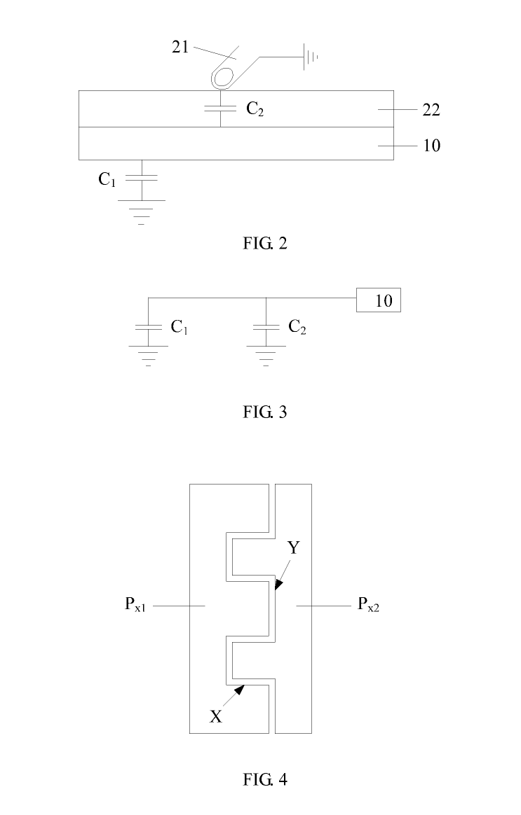

Further referring to FIG. 2, the first electrode pattern Pₓ and the second electrode pattern P_{y} respectively form a self-capacitor C1 to the earth. When finger 21 touches a cover 22 of a touch screen, owing to the human body can be equivalent to the earth, a capacitor C2 is formed between the finger 21 and the first electrode pattern Pₓ or between the finger 21 and the second electrode pattern P_{y}, the capacitor C1 and the capacitor C2 form a parallel circuit as illustrated in FIG. 3 to thereby increase a capacitance of corresponding sensing unit. Accordingly, by detecting a capacitance change of each sensing unit to judge whether to produce an touch event, and through a coordinate information of the first electrode pattern Pₓ and the second electrode pattern P_{y} on the touch screen to judge a location of a touch point.

The first electrode pattern Pₓ of the embodiment is equivalent to increase a contact area between electrode patterns in a sensing unit, when finger 21 slides around the edge region of the touch screen, a capacitance change between electrode patterns of the edge region is smaller, the capacitance change sliding from one touch point to another touch point is consistent with a linear change, thus it is able to accurately judge a sliding track of the finger 21.

Based on the objective of the invention, embodiments of the invention can further dispose a first electrode pattern of the conductive layer structure 10 with other structures, as shown in FIG. 4, a first electrode pattern Pₓ can be an “E” shaped structure, a first side X of a first sub-electrode pattern Pₓ₁ includes two recesses with a right angle structure, at this time a second side Y of a second sub-electrode pattern Pₓ₂ includes two convexes meshed with the two recesses, the first side X and the second side Y are meshed with each other to thereby make the first sub-electrode pattern Pₓ₁ and the second sub-electrode pattern Pₓ₂ together define a rectangular shape.

An embodiment of the invention further provides a liquid crystal display device with touch-sensing function, includes a display assembly and a touch-sensing assembly, the display assembly and the touch-sensing assembly share a common electrode, the touch-sensing assembly includes the conductive layer structure 10 above mentioned disposed opposite to the common electrode.

On this basis, the foregoing discussion only is some embodiments of the invention, but it is not therefore limited to the protection scope of the invention, any equivalent structures or equivalent processes made according to the specification and the accompanying drawings of the invention, such as the mutual combination of the technical characteristics of each embodiment, or directly or indirectly used in other related technical field, should be included within the protection scope of the invention.

What is claimed is:

1. A conductive layer structure comprising a plurality of first electrode patterns and a plurality of rectangular second electrode patterns, the plurality of second electrode patterns being arranged in a rectangular array, the plurality of first electrode patterns being arranged around the plurality of second electrode patterns; the plurality of second electrode patterns arranged in a rectangular array being disposed with two rows of the first electrode patterns on a row direction thereof respectively located above and below the plurality of second electrode patterns, and further being disposed with two columns of the first electrode patterns on a column direction thereof respectively located left and right of the plurality of second electrode patterns; a length and a width of each of the plurality of first electrode patterns respectively are equal to a length and a width of each of the plurality of second electrode patterns; wherein each of the plurality of first electrode patterns comprises a first sub-electrode pattern and a second sub-electrode pattern, a first side of the first sub-electrode pattern near the second sub-electrode pattern and a second side of the second sub-electrode pattern near the first sub-electrode pattern each are disposed with a right angle structure, and the first side and the second side are meshed with each other to thereby make the first sub-electrode pattern and the second sub-electrode pattern together define a rectangular shape, and a distance between one of the plurality of first electrode patterns and one of the plurality of second electrode patterns adjacent thereto is equal to a distance between the first sub-electrode pattern and the second sub-electrode pattern.

2. A conductive layer structure comprising a plurality of first electrode patterns and a plurality of rectangular second electrode patterns, the plurality of second electrode patterns being arranged in a rectangular array, the plurality of first electrode patterns being arranged around the plurality of second electrode patterns; wherein, each of the plurality of first electrode patterns comprises a first sub-electrode pattern and a second sub-electrode pattern, a first side of the first sub-electrode pattern near the second sub-electrode pattern and a second side of the second sub-electrode pattern near the first sub-electrode pattern each are disposed with a right angle structure, the first side and the second side are meshed with each other to thereby make the first sub-electrode pattern and the second sub-electrode pattern together define a rectangular shape.

3. The conductive layer structure as claimed in claim 2, wherein a length and a width of each of the plurality of first electrode patterns respectively are equal to a length and a width of each of the plurality of second electrode patterns.

4. The conductive layer structure as claimed in claim 3, wherein the first sub-electrode pattern and the second sub-electrode pattern each are a “L” shaped structure.

5. The conductive layer structure as claimed in claim 3, wherein the first sub-electrode pattern is an “E” shaped structure, the first side of the first sub-electrode pattern comprises two recesses with the right angle structure, and the second side of the second sub-electrode pattern comprises two convexes meshed with the two recesses.

6. The conductive layer structure as claimed in claim 2, wherein a distance between one of the plurality of first electrode patterns and an adjacent one of the plurality of second electrode patterns is equal to a distance between the first sub-electrode pattern and the second sub-electrode pattern.

7. The conductive layer structure as claimed in claim 2, wherein the plurality of second electrode patterns arranged in a rectangular array are disposed with two rows of the first electrode patterns on a row direction thereof respectively located above and below the plurality of second electrode patterns, and further are disposed with two columns of the first electrode patterns on a column direction thereof respectively located left and right of the plurality of second electrode patterns.

8. The conductive layer structure as claimed in claim 7, wherein each of the plurality of first electrode patterns located on the row direction rotates with 90 degrees to the right or to the left would become the same as corresponding one of the plurality of first electrode patterns located on the column direction.

9. The conductive layer structure as claimed in claim 8, wherein the two columns of the first electrode patterns located on the column direction are symmetrical with respect to a first axis, and two rows of the first electrode patterns located on the row direction are symmetrical with respect to a second axis, the first axis and the second axis respectively are central axes of the plurality of second electrode patterns arranged in a rectangular array on the column direction and on the row direction.

10. The conductive layer structure as claimed in claim 8, wherein the two columns of the first electrode patterns located on the column direction are the same, and the two rows of the first electrode patterns located on the row direction are the same.

11. A liquid crystal display device with touch-sensing function, wherein the liquid crystal display device comprises a display assembly and a touch-sensing assembly, the display assembly and the touch-sensing assembly share a common electrode, the touch-sensing assembly comprises a conductive layer structure disposed opposite to the common electrode, the conductive layer structure comprises a plurality of first electrode patterns and a plurality of rectangular second electrode patterns, the plurality of second electrode patterns are arranged in a rectangular array, the plurality of first electrode patterns are arranged around the plurality of second electrode patterns, each of the plurality of first electrode patterns comprises a first sub-electrode pattern and a second sub-electrode pattern, a first side of the first sub-electrode pattern near the second sub-electrode pattern and a second side of the second sub-electrode pattern near the first sub-electrode pattern each are disposed with a right angle structure, the first side and the second side are meshed with each other to thereby make the first electrode pattern and the second sub-electrode pattern together define a rectangular shape.

12. The liquid crystal display device as claimed in claim 11, wherein a length and a width of each of the plurality of first electrode patterns respectively are equal to a length and a width of each of the plurality of second electrode patterns.

13. The liquid crystal display device as claimed in claim 12, wherein the first sub-electrode pattern and the second sub-electrode pattern each are a “L” shaped structure.

14. The liquid crystal display device as claimed in claim 12, wherein the first sub-electrode pattern is “E” shaped structure, the first side of the first sub-electrode pattern comprises two recesses with the right angle structure, and the second side of the second sub-electrode pattern comprises two convexes meshed with the two the recesses.

15. The liquid crystal display device as claimed in claim 11, wherein a distance between one of the plurality of first electrode patterns and an adjacent one of the plurality of second electrode patterns is equal to a distance between the first sub-electrode pattern and the second sub-electrode pattern.

16. The liquid crystal display device as claimed in claim 11, wherein the plurality of second electrode patterns arranged in a rectangular array are disposed with two rows of the first electrode patterns on a row direction thereof respectively located above and below the plurality of second electrode patterns, and further are disposed with two columns of the first electrode patterns on a column direction thereof respectively located left and right of the plurality of second electrode patterns.

17. The liquid crystal display device as claimed in claim 16, wherein each of the plurality of first electrode patterns located on the row direction rotates with 90 degrees to the right or to the left would become the same as the first electrode pattern located on the column direction.

18. The liquid crystal display device as claimed in claim 17, wherein the two columns of the first electrode patterns located on the column direction are symmetrical with respect to a first axis, and two rows of the first electrode patterns located on the row direction are symmetrical with respect to a second axis, the first axis and the second axis respectively are central axes of the plurality of second electrode patterns arranged in a rectangular array on the column direction and on the row direction.

19. The liquid crystal display device as claimed in claim 17, wherein the two columns of the first electrode patterns located on the column direction are the same, and the two rows of the first electrode patterns located on the row direction are the same.
